(19) United States
(12) Patent Application Publication
(10) Pub. No.: US 2007/0136314 A1
(43) Pub. Date: Jun. 14, 2007

(54) Contents providing system and method for preventing improper contents purging and method for managing contents

(76) Inventors: Seung Jo Bae, Daejeon (KR); Jin Mee Kim, Daejeon (KR); Young Choon Woo, Daejeon (KR); Myung Joon Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/633,829

(22) Filed: Dec. 5, 2006

(30) Foreign Application Priority Data
Dec. 8, 2005 (KR) 10-2005-0119822
Feb. 9, 2006 (KR) 10-2006-0012573

(51) Int. Cl. G06F 17/30

(52) U.S. Cl. 707/10

(57) ABSTRACT

Provided is a contents providing system. The system includes a storing unit, a plurality of server nodes, a dispatcher node, and a storing/deleting management node. The storing unit stores synchronization data according to a service state of each contents data that can be provided. The plurality of server nodes change synchronization data of contents, and provides the contents service in response to a contents service request input via a network. The dispatcher node checks a service state of contents to select a server node that is to provide the corresponding contents service, and changes synchronization data to transmit address data of the selected server node and a corresponding contents file data to a client that has requested the contents service. The storing/deleting management node manages storing and deleting of contents data stored in a contents storing unit with reference to the synchronization data stored in the storing unit.

### CLAIM OF PRIORITY

This application claims the benefits of Korean Patent Application No. 2005-0119822 filed on Dec. 8, 2005 and Korean Patent Application No. 2006-0012573 filed on Feb. 9, 2006 in the Korean Intellectual Property Office, the disclosures of which are incorporated herein by reference.

### BACKGROUND OF THE INVENTION

1. Field of the Invention

The present invention relates to a contents providing system for preventing improper contents purging and, more particularly, to a contents providing system and method for preventing improper contents purging, and a method for managing contents, capable of improving reliability of service by fundamentally preventing service that is being or to be provided to a client from being stopped due to improper deletion of a contents file.

2. Description of the Related Art

As Internet user increases constantly, an Internet-based contents providing server such as a multimedia streaming server is established in the form of a cluster. That is, recently, contents providing servers are established to include multiple nodes, not a single node, capable of providing extensibility and high availability.

FIG. 1 is a schematic block diagram of a conventional contents providing system. Particularly, FIG. 1 is a schematic block diagram in the form of a cluster that includes independent multiple nodes.

Referring to FIG. 1, the conventional contents providing system 10 includes a dispatcher node 11, a plurality of server nodes 12a, 12b, 12c, and 12d, and a storing/deleting management node 13. Each of the nodes is connected to the same communication network (e.g., a local area network (LAN)) 20 via a different path. That is, the dispatcher node 11 is connected to a LAN 20 via a first path 21, and the respective server nodes 12a, 12b, 12c, and 12d is connected to the LAN 20 via a second path to a fifth path 22a, 22b, 22c, and 22d. The storing/deleting management node 13 is connected to the LAN 20 via a sixth path 23.

The dispatcher node 11 is responsible for controlling a load between all the server nodes 12a-12d by managing all the server nodes 12a-12d within the contents providing system 10 and assigning a contents service request received via the LAN 20 to one of the server nodes 12a-12d.

The server nodes 12a-12d perform an operation (i.e., providing of contents service) assigned to the server nodes 12a-12d. Particularly, the server nodes 12a-12d perform the operation independently. That is, each of the server nodes 12a-12d becomes an object of an independent operation under the contents providing system 10 realized in the form of a cluster. At this point, the server nodes 12a-12d can store contents that are to be provided by the server nodes 12a-12d. Also, the contents that are to be provided by the server nodes 12a-12d can be stored using a separate storing element.

The storing/deleting management node 13 manages storing and deletion of contents stored in the contents providing system 10.

Generally, when providing contents service, the contents providing system 10 can store only a limited amount of contents files due to limitation in capacity of a storage device. Particularly, in case of a large capacity video file, the capacity of the storage device is very important. Therefore, it is required to delete contents files stored already and store new contents files in order to provide swift contents service. The storing/deleting management node 13 manages storing and deleting of contents files stored in the contents providing system 10 to meet this requirement.

At this point, the nodes 11, 12a-12d, and 13 are logical divisions, and one physical device can simultaneously perform two or more functions. For example, one physical system can simultaneously perform functions of the dispatcher node 11 and the server node 12a. Also, the nodes 11, 12a-12d, and 13 can operate independently of each other.

FIG. 2 is a view explaining a contents providing procedure of the contents providing system exemplified in FIG. 1. Particularly, FIG. 2 explains a general redirection type scheduling method applied to the content providing system exemplified in FIG. 1. At this point, the contents providing system 10 should define a virtual Internet protocol (VIP), which is a network address in order to realize the scheduling. The VIP is an address actually mapped in advance to a network address of the dispatcher node 11 and made public to the outside by a manager. Therefore, a first service request from the outside is always made via the dispatcher node 11.

Referring to FIG. 2, the contents providing system 10 provides corresponding contents service in response to a request of a contents reproduction apparatus 30 connected via a network (not shown). At this point, the contents reproduction apparatus 30 connects to the dispatcher node 11 firstly and requests contents service (S31). The dispatcher node 11 selects a server node that is to provide corresponding contents service, and delivers data regarding the sever node (e.g., address data) and contents file data to the contents reproduction apparatus 30 in response to the contents service request (S33). The example shown in FIG. 2 illustrates the case where the sever node 12a is selected as a sever node that is to provide corresponding contents service. Therefore, the dispatch node 11 of FIG. 2 delivers address data of the server node 12a to the contents reproduction apparatus 30.

At this point, the contents reproduction apparatus 30 generates a new path to the server node 12a on the basis of the address data and requests the service node 12a to provide contents service via the path (S35). The server node 12a provides corresponding contents service to the contents reproduction apparatus 30 via the path (S37).

The contents providing system including the multiple nodes sets a path between a corresponding node and a client for each service state to provide service. That is, as in the example shown in FIG. 2, the contents providing system sets a path (what is called an “initial path”) between a client and a dispatcher node when service is requested, and sets a path (what is called a “redirection path”) between a client and a server node when service is provided. Therefore, the contents providing system sequentially activates two kinds of paths (what is called the initial path and the redirection path).

The above-described contents providing system 10 does not consider at all contents deletion problem that is frequently generated in a high capacity contents server. Therefore, there is a problem that contents files may be deleted at an instant when a client actually receives service (that is, before a redirection path is activated or during an activation in order to actually receive service) or while service is provided via a redirection path. When the contents files are improperly deleted in this manner, serious problems that the client does not receive any response from the server or service that has been provided to the client is abruptly stopped.

The reason these problems occur is because there is no synchronization method of controlling cluster nodes although scheduling, contents service, and deletion of contents files can be performed by the physically different cluster nodes. Actually, when improper deletion of contents files occurs, it is difficult to provide high quality service to clients.

### SUMMARY OF THE INVENTION

The present invention has been made to solve the foregoing problems of the prior art and therefore an aspect of the present invention is to provide a contents providing system, a contents providing method, and a contents management method for preventing improper deletion of contents, capable of providing high quality reliable service to clients.

Another aspect of the present invention is to provide a contents providing system, a contents providing method, and a contents management method for preventing improper deletion of contents, capable of fundamentally preventing service that has been or is to be provided to a client from being stopped due to improper deletion of contents files at a contents providing system.

Still another aspect of the present invention is to provide a contents providing system, a contents providing method, and a contents management method for preventing improper deletion of contents, capable of managing synchronization data between a plurality of nodes in a contents providing system including the plurality of nodes.

According to an aspect of the invention for realizing the above objects, there is provided a contents providing system for preventing improper deletion of contents, the system including: a contents storing unit for storing contents data that can be provided; a synchronization data storing unit for storing synchronization data according to a service state of each contents data stored in the contents storing unit; a plurality of server nodes for changing synchronization data of contents, and providing the contents service in response to a contents service request input via a network; a dispatcher node for checking a service state of contents from the synchronization data storing unit to select a server node that is to provide corresponding contents service, and changing synchronization data of corresponding contents to transmit address data of the selected server node and corresponding contents file data to a client that has requested the contents service in response to a contents service request input via a network; and a storing/deleting management node for managing storing and deleting of contents data stored in the contents storing unit with reference to the synchronization data stored in the synchronization data storing unit.

According to another aspect of the invention for realizing the above objects, there is provided a contents providing method for preventing improper deletion of contents, the method including: initialing synchronization data of each contents data that is to be provided; selecting a server node that is to provide first contents in response to a service request for the first contents input via a network; changing synchronization data of the first contents; transmitting address data of the server node and file data of the first contents to a first client that has requested the first contents; and changing synchronization data of the first contents and providing the first contents in response to the service request of the first client.

According to still another aspect of the invention for realizing the above objects, there is provided a contents management method for preventing improper deletion of contents, the management method including: initialing, at a contents providing system, synchronization data of each contents data that is to be provided; and changing synchronization data of contents on the basis of a content service request and the contents providing results.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of a conventional contents providing system;

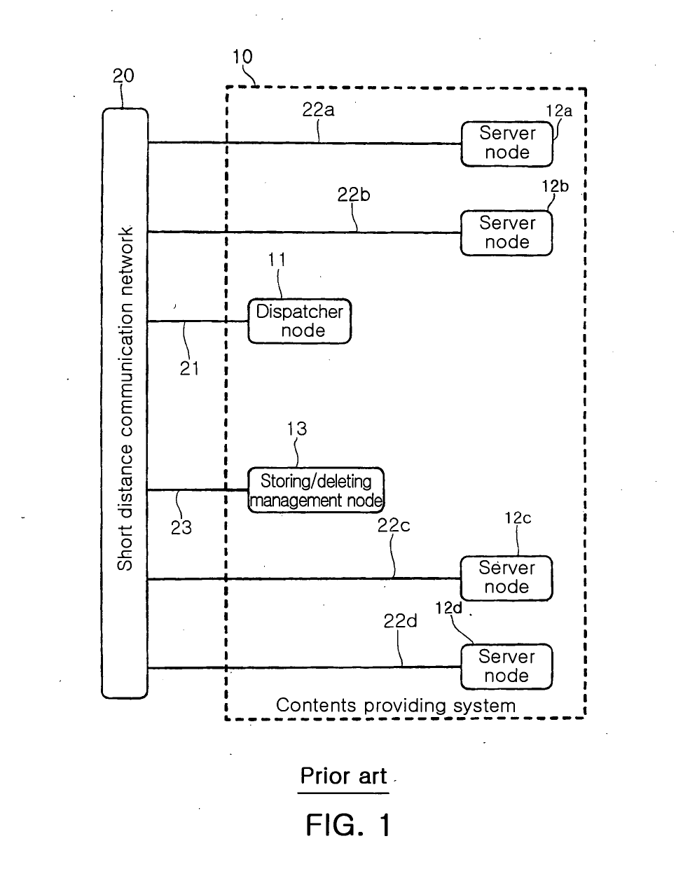

FIG. 2 is a view explaining a contents providing procedure of the contents providing system exemplified in FIG. 1;

FIG. 3 is a schematic block diagram of a contents providing system according to an embodiment of the present invention;

FIG. 4 is a view illustrating an example of a database structure for the contents providing system of FIG. 3 to manage synchronization data for each content;

FIG. 5 is a view explaining a contents providing procedure of the contents providing system exemplified in FIG. 3;

FIG. 6 is a flowchart illustrating a processing operation at a dispatcher node exemplified in FIG. 3;

FIG. 7 is a flowchart illustrating a processing operation at the server node exemplified in FIG. 3;

FIG. 8 is a flowchart illustrating a processing operation at a storing/deleting management node exemplified in FIG. 3;

FIG. 9 is a flowchart of a contents providing method according to an embodiment of the present invention; and

FIG. 10 is a state transition diagram exemplifying a state of synchronization data depending on a contents service providing state at a contents providing system according to an embodiment of the present invention.

### DETAILED DESCRIPTION OF THE PREFERRED EMBODIMENT

Certain or exemplary embodiments of the present invention will now be described in detail with reference to the accompanying drawings. It should be noted that like reference numerals in the drawings denote like elements though they appear on different drawings. In the description of the present invention, detailed explanations of known functions or constructions will be omitted in the case where they unnecessarily obscure the sprite of the present invention.

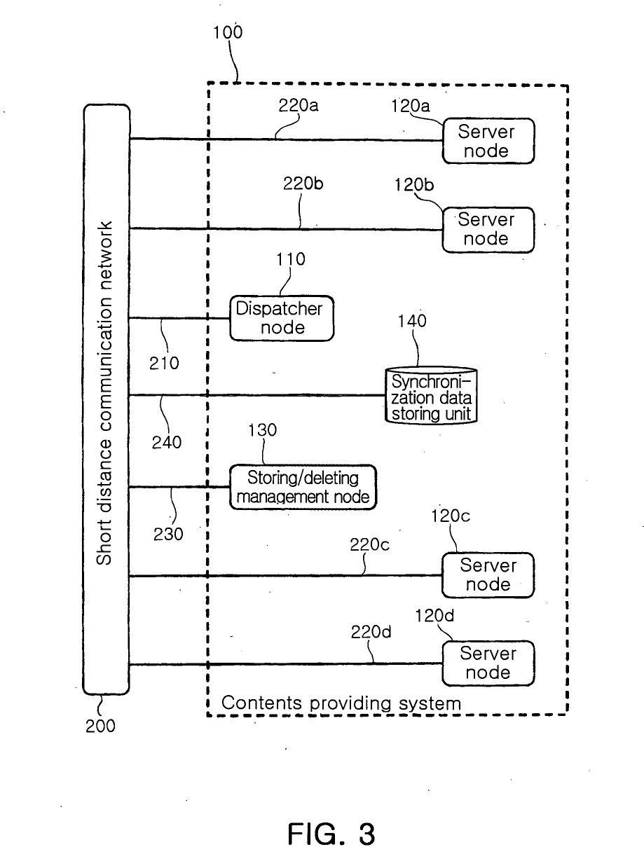

FIG. 3 is a schematic block diagram of a contents providing system according to an embodiment of the present invention.

Referring to FIG. 3, the contents providing system for preventing improper deletion of contents includes a contents storing unit (not shown), a dispatcher node 110, a plurality of server nodes 120a, 120b, 120c, and 120d, a storing/deleting management node 130, and a synchronization data storing unit 140. The nodes 110, 120a, 120b, 120c, 120d, 130, and 140 are connected to the same communication network (e.g., a local area network (LAN) 200 via different paths, respectively. That is, the dispatcher node 110 is connected to the LAN 200 via a first path 210, and the plurality of server nodes 120a to 120d are connected to the LAN 200 via a second path to a fifth path 220a, 220b, 220c, and 220d, respectively. The storing/deleting management node 130 is connected to the LAN 200 via a sixth path 230, and the synchronization data storing unit 140 is connected to the LAN 200 via a seventh path 240. At this point, the contents storing unit can exist as a separate node, or can be separated into a plurality of parts assigned to the plurality of server nodes 120a to 120d. Here, it is noted that the contents providing system for preventing improper deletion of contents is preferably applied to a cluster-based system. However, the contents providing system can be applied to other system.

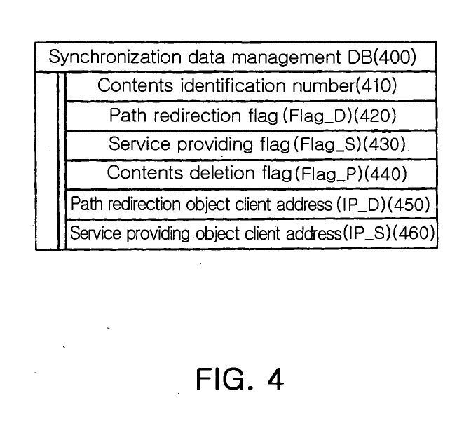

The synchronization data storing unit 140 stores synchronization data according to a service state of each contents data stored in the system. At this point, the “synchronization data” means a synchronization global variable that needs to be shared for synchronization by all of the nodes 110, 120a-120d, and 130 within the system. Preferably, the “synchronization data” is defined for each contents file because one content is copied as a plurality of files and can be serviced by the plurality of nodes for swift service. Also, the synchronization data storing unit 140 is shared by all the nodes 110, 120a-120d, and 130 included in the system. Also, it is preferable that the synchronization data storing unit 140 can access current values of synchronization global variables to create, modify, or delete the synchronization global variables. Data and detailed descriptions thereof stored in the synchronization data storing unit 120 will be described with reference to FIG. 4.

The dispatcher node 110 manages all the sever nodes 120a-120d within the contents providing system 100 and assigns a contents service request received via the LAN 200 to one of the server nodes 120a-120d. For this purpose, the dispatcher node 110 checks a service state of corresponding contents stored in the synchronization data storing unit 140, selects the server node that is to provide corresponding contents service, changes synchronization data of the corresponding contents, and transmits address data of the selected server node and data of the corresponding contents file to a client that has requested the corresponding contents service.

The server nodes 120a-120d changes synchronization data of corresponding contents and provides the corresponding contents service in response to a contents service request input via the LAN 200. At this point, preferably, each of the server nodes 120a-120d operates in response to a service request of a client that has received address data of the corresponding server node from the dispatcher node 110.

Particularly, the server nodes 120a-120d perform contents providing service independently. That is, each of the server nodes 120a-120d serves as an object of an independent operation under the contents server system 100 including a cluster form. At this point, contents the server nodes 120a-120d provide can be stored by each of the server nodes 120a-120d, or can be stored using a separate storing element.

The storing/deleting management node 130 manages operations of storing and deleting contents data stored in the contents providing system 100 with reference to synchronization data stored in the synchronization data storing unit 140. At this point, the managing of the operations of storing and deleting the contents by the storing/deleting management node 130 is designed for providing swifter contents service using the contents providing system 100 having limited storing capacity.

Meanwhile, the nodes 110, 120a-120d, 130, and 140 are logical divisions, and one physical device can simultaneously perform two or more functions. For example, one physical system can simultaneously perform functions of the dispatcher node 110 and the server node 120a. Also, the nodes 110, 120a-120d, 130, and 140 can operate independently of each other.

Improper deletion of contents file can be prevented by applying the contents providing system to a cluster-based system.

FIG. 4 is a view illustrating an example of a database structure for the contents providing system of FIG. 3 to manage synchronization data for each content. Referring to FIG. 4, a synchronization data management database (DB) 400 includes a contents identification number 410, a path redirection flag Flag_Dispatcher 420, a service providing flag Flag_Service 430, a contents deletion flag Flag_Purging 440, a path redirection object client address IP_Dispatcher 450, and a service providing object client address IP_Service 460. At this point, the path redirection flag Flag_Dispatcher 420, the service providing flag Flag_Service 430, and the contents deletion flag Flag_Purging 440 are flag type fields or variables having one of “Yes(On)” and “No(off)”, which are only two variables. The path redirection object client address IP_Dispatcher 450 and the service providing object client address IP_Service 460 are address storing type fields or variables for storing a network address of a client.

The contents identification number 410 stores data for identifying corresponding contents.

The path redirection flag Flag_Dispatcher 420 represents whether address data of a server node that is to provide the corresponding contents is informed of to the client. That is, the Flag_Dispatcher 420 represents whether an address of a server node (one of the server nodes 120a-120d) that is to provide the service is informed of to the client after the dispatcher node 110 selects the server node (one of the server nodes 120a-120d) in the example of FIG. 3. Accordingly, it is preferable that a state of the Flag_Dispatcher 420 is changed by the dispatcher node 110 and the server nodes 120a-120d. At this point, the dispatcher node 110 sets a value of the Flag_Dispatcher 420 to “Yes”. On the other hand, the server node 120 sets the value of the Flag_Dispatcher 420 to “No”.

The service providing flag Flag_Service 430 represents whether the selected server node is actually providing the corresponding contents. At this point, it is preferable that a state of the Flag_Service 430 is changed by the selected server node (one of the server nodes 120a-120d). For example, the server node 120a changes the state of the Flag_Service 430 into “Yes” before service regarding arbitrary contents is started, and changes the state of the Flag_Service 430 into “No” when the corresponding service is ended.

The contents deletion flag Flag_Purging 440 represents whether the storing/deleting management node 130 is deleting corresponding contents. At this point, it is preferable that a state of the Flag_Purging 440 is changed by the storing/deleting management node 130. For example, the storing/deleting management node 130 changes the state of the Flag_Purging 440 into “Yes” before deleting corresponding contents, and changes the state of the Flag_Purging 440 into “No” when the deleting operation is ended.

A first address data IP_D 450 (the path redirection object client address) represents address data of a client that has been informed of address data of the server node selected by the dispatcher node 110. At this point, it is preferable that the IP_D 450 is changed by the dispatcher node 110.

A second address data IP_S 460 (the service providing object client address) represents address data of a client that is receiving contents service from a server node. At this point, it is preferable that the IP_S 460 is changed by a server node (one of the server nodes 120a-120d).

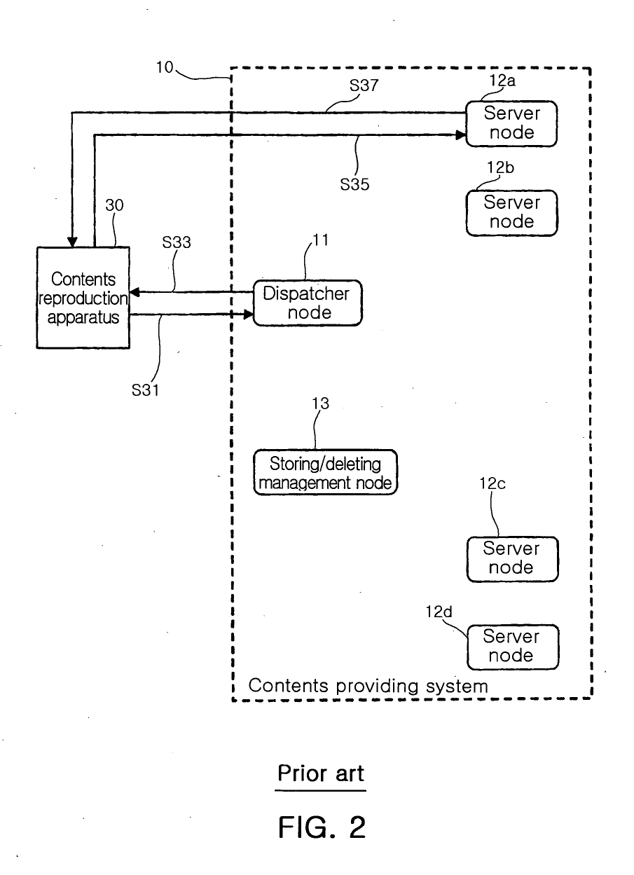

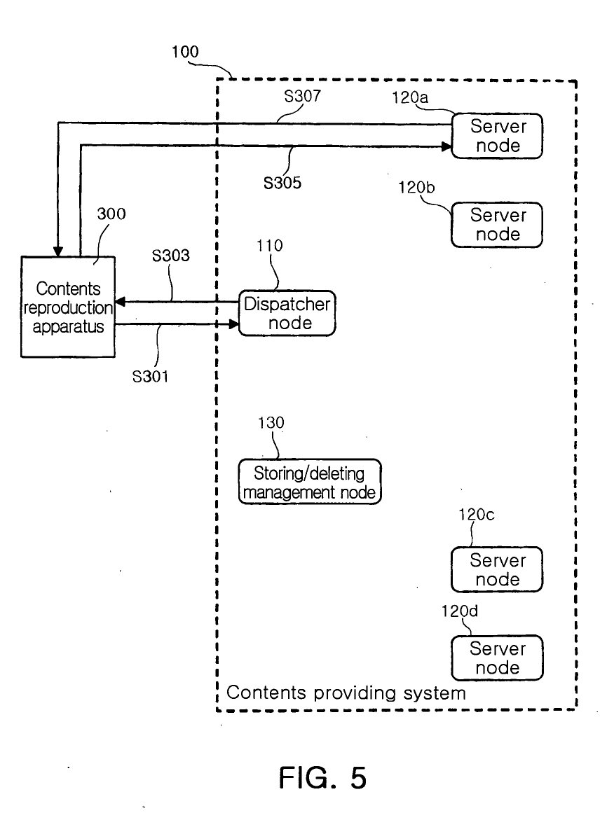

FIG. 5 is a view explaining a contents providing procedure of the contents providing system exemplified in FIG. 3. Referring to FIG. 5, the contents providing system 100 provides corresponding contents service in response to a request of a contents reproduction apparatus 300 connected via a network (not shown). As mentioned in the description with reference to FIG. 2, the contents reproduction apparatus 300 connects to the dispatcher node 110 firstly and requests contents service (S301). Then, the dispatcher node 110 selects a sever node that is to provide corresponding contents service and transmits data (e.g., address data) regarding the server node and contents file data to the contents reproduction apparatus 300 in response to the service request (S303). At this point, preferably, the dispatcher node 110 selects an optimum server node on the basis of synchronization data stored in the synchronization data storing unit 140.

The example of FIG. 5 illustrates the case where the server node 120a is selected as the optimum server node. Therefore, referring to FIG. 5, the dispatcher node 110 delivers address data of the server node 120a to the contents reproduction apparatus 300. Also, the dispatcher node 110 changes a value of the Flag_Dispatcher 420 of the corresponding contents into “Yes”, and stores a network address of the contents reproduction apparatus 300 in the IP_D 450.

Then, the contents reproduction apparatus 300 creates a new path to the server node 120a on the basis of the address data, and requests the server node 120a to provide contents service using the new path (S305). The server node 120a provides the corresponding contents service to the contents reproduction apparatus 300 using the new path (S307). At this point, the server node 120a changes the Flag_S 430 of the corresponding contents into “Yes”, and stores a network address of the contents reproduction apparatus 300 in the IP_S 460. Also, the server node 120a compares an address stored in the IP_D 450 of the corresponding contents with the address stored in the IP_S 460 of the corresponding contents. When the two address are the same, the server node 120a changes the Flag_D 420 of the corresponding contents into “No”.

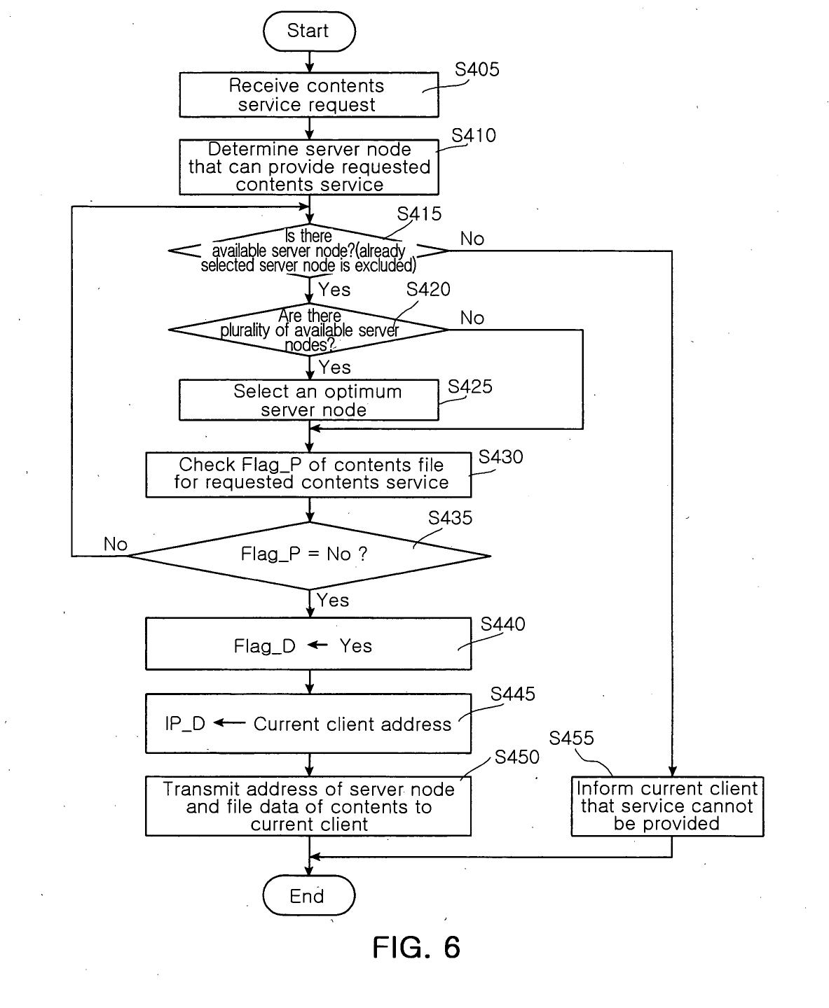

FIG. 6 is a flowchart illustrating a processing operation at a dispatcher node exemplified in FIG. 3. Referring to FIGS. 3 and 6, when the dispatcher node 110 receives a contents service request from a client (e.g., a contents reproduction apparatus) (S405), the dispatcher node 110 analyzes the received service request to determine an available server node that can provide contents service (S410).

After that, the dispatcher node 110 judges whether there exist any available server node on the basis of the determination results (S415). When there is no available server node as a result of the judgment (S415), the dispatcher node 110 informs the current client that contents service is not possible (S455).

Meanwhile, when there exist any available server node as a result of the judgment (S415), the dispatcher node 110 judges whether there exist a plurality of available server nodes (S420). When there exist the plurality of available server nodes as a result of the judgment (S420), the dispatcher node 110 analyzes support states of the plurality of available server nodes to select an optimum server node (S425). When there exists only one available server node, the dispatcher node 110 selects the one available server node.

Also, the dispatcher node 110 checks the Flag_P of a contents file in order to provide the requested contents service (S430). That is, the dispatcher node 110 checks whether a value of “Flag_P”, which is a synchronization global variable for a contents file the selected server node is to provide, is “No” to judge whether the corresponding contents is being deleted.

When the value of the “Flag_P” of the corresponding contents is “No” (i.e., the corresponding contents are not being deleted) (S435) as a result of the checking (S430), the dispatcher node 110 changes the value of the “Flag_D” of the contents into “Yes” (S440). This is for representing that address data of the server node that is to provide the contents has been informed of to the client. By doing so, deletion of the corresponding contents file can be prevented.

Also, after storing an address of the client in the first address data IP_D of the contents (S445), the dispatcher node 110 transmits address data of the selected server node and file data of the corresponding contents to the client that has requested the contents service (S450).

Meanwhile, when there is no contents file whose Flag_P value is “No” as a result of the judgment in the operation S435, it means that the contents file is being deleted and service cannot be provided. Therefore, other server node should be selected. On the other hand, when the Flag_P value is “Yes”, the dispatcher node 110 repeatedly performs the operations since the operation S415. At this point, it should be noted that a server node that has been already selected during the operation S415 should be excluded during a retest procedure.

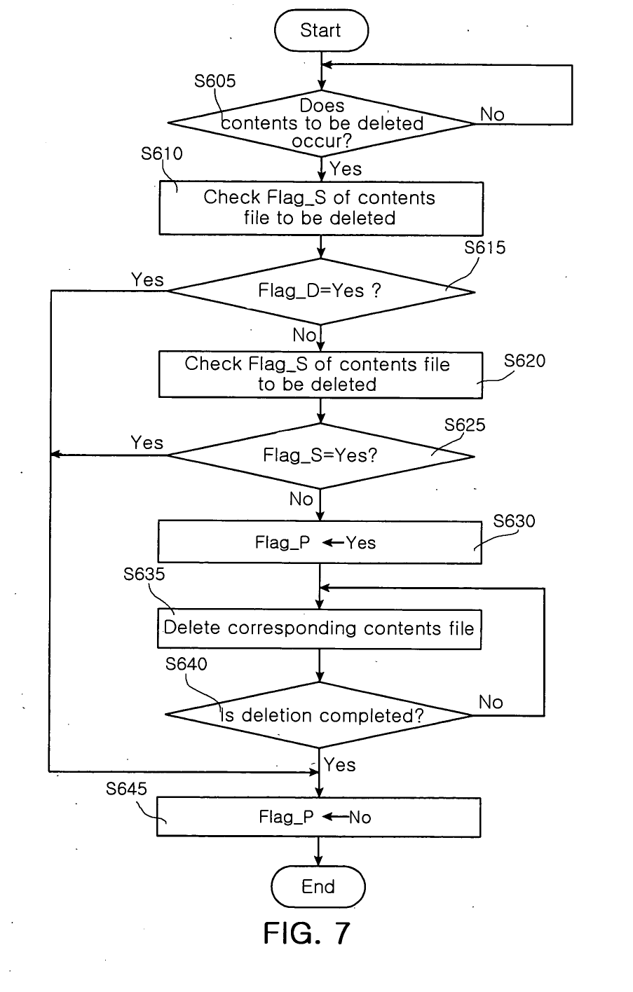

FIG. 7 is a flowchart illustrating a processing operation at the server node 120a exemplified in FIG. 3. Particularly, FIG. 7 illustrates an example where the server node 120a is selected in response to a contents service request of a client.

Referring to FIG. 7, the server node 120a waits for a service request from a client. When the service request is received from the client (S505), the server node 120a changes a value of a Flag_S of service-requested contents into “Yes” (S510), records a network address of a current client in an IP_S of the corresponding contents (S515), and provides corresponding contents service to the corresponding client (S520). For reference, at this point, since a synchronization variable Flag_D of the corresponding contents has been changed into “Yes” by the dispatcher node 110, the corresponding contents already cannot be deleted before the Flag_S changes into “Yes”. Also, the changing of the Flag_S of the contents into “Yes” during the operation S510 is for representing the service-requested contents are in service.

Meanwhile, after service starts, the serer node 120a checks whether an IP_D and an IP_S are the same of the corresponding contents (S525).

When the two values IP_D and IP_S are the same as a result of the checking in the operation S525, the server node 120a changes a Flag_D of the corresponding contents into “No” (S530). This is for the Flag_D to represent that address data of the server node that is to provide the contents can be informed of to other client.

Meanwhile, when the two values IP_D and IP_S are not the same as a result of the checking in the operation S525, the server node 120a does not change Flag_D of the corresponding contents. At this point, since the fact that the two values IP_D and IP_S are not the same means a new other client, not a client currently connected to the server node, is to request the same contents file again, a value of the Flag_D, which is a synchronization global variable, is not changed into “No”.

Also, when service of the contents currently in service is ended (S535), the server node 120a changes a value of a Flag_S of the contents into “No” (S540). This is for representing the service of the corresponding contents has been ended.

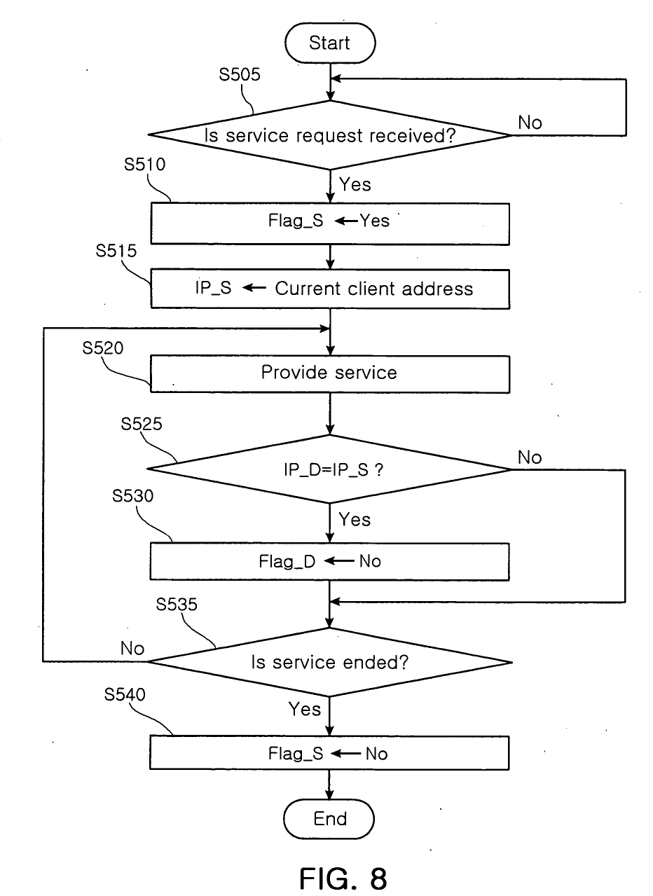

FIG. 8 is a flowchart illustrating a processing operation at a storing/deleting management node exemplified in FIG. 3.

Referring to FIG. 8, when contents to be deleted occur during an operation of the contents providing system 100 (S605), the storing/deleting management node 130 checks a Flag_D of the corresponding contents (S610).

When the Flag_D, which is a synchronization global variable for a corresponding contents file, is “Yes” (S615) as a result of the checking in the operation S610, it means that the server node 120a is providing or is scheduled to provide the corresponding contents file. Therefore, the contents are not deleted and the service is ended. In this case, a method for deleting contents again includes a method of constantly checking a value of a Flag_D, which is a synchronization global variable, periodically in a busing-waiting manner, a method of checking the value of the Flag_D after a predetermined time, and a method of abandoning from the beginning. However, since any of the above methods does not have an influence on a synchronization method, the present invention does not assume a specific method for deleting contents again.

Meanwhile, when the value of a Flag_D, which is a synchronization global variable for the corresponding contents file is “No” as a result of the checking in the operation S610, a Flag_S, which is a synchronization global variable for the corresponding contents file is checked (S620).

When the Flag_S, which is a synchronization global variable for the corresponding contents file, is “Yes” as a result of the checking in the operation S620, it also means the corresponding contents are in service. Therefore, the contents are not deleted, and the service is ended.

When the Flag_S, which is a synchronization global variable, is also “NO” as a result of the checking in the operation S620, a Flag_P, which is a synchronization global variable for the corresponding contents file, is changed into “Yes” (S630), and the corresponding contents file is deleted (S635). At this point, the fact that both Flag_D and Flag_S are “No” means address data of a server node that is to provide the contents can be informed of to other client, the contents are not in service, and thus, the corresponding contents can be deleted.

Also, when the deletion of the contents is completed (S640), the storing/deleting management node 130 changes a value of a Flag_P into “No” so that the Flag_P represents the corresponding contents are not being deleted (S645).

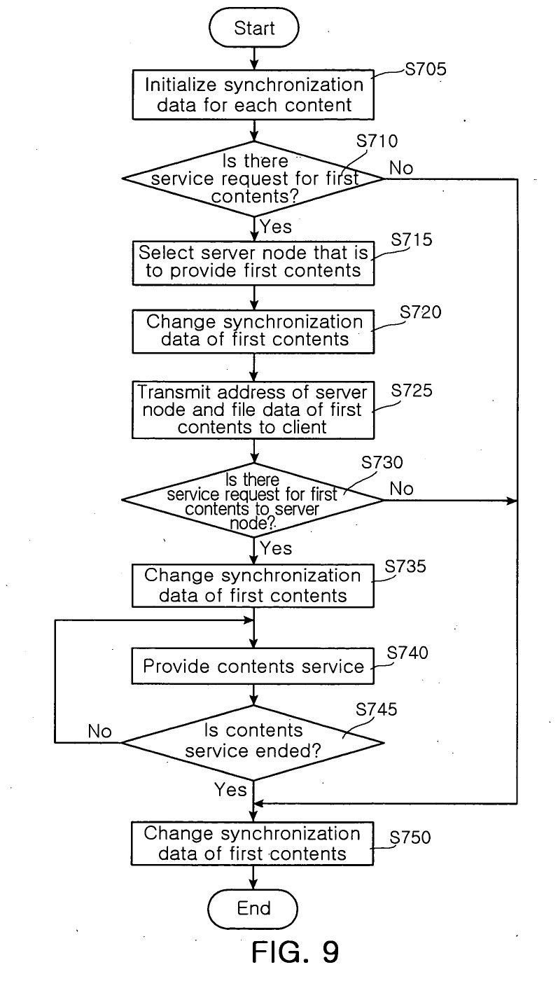

FIG. 9 is a flowchart of a contents providing method according to an embodiment of the present invention. Particularly, FIG. 9 illustrates an example of a method for providing contents in a contents providing system realized in a cluster form. The contents providing method will be described below with reference to FIG. 9.

Before the method for providing contents is performed, the contents providing system initializes synchronization data of each contents data in the first place (S705). When a service request for the first contents is input via a network (S710), the contents providing system selects a server node that is to provide the first contents in response to the service request (S715). At this point, since the service request is input via the dispatcher node of the contents providing system, it is preferable that the dispatcher node checks a Flag_P of the first contents and performs subsequent processes when the first contents are not being deleted as a result of the checking in order to perform the selecting in the operation S715.

Also, when the contents providing system selects the server node that is to provide the first contents, the dispatcher node changes synchronization data of the first contents (S720). That is, it is preferable that the dispatcher node changes a value of a Flag_D of the first contents into “Yes”, and stores an address of the first client in an IP_D of the first contents. At this point, the changing of the Flag_D into “Yes” is for representing address data of the server node that is to provide the first contents has been informed of to a predetermined client.

After the operation S720 is performed, the dispatcher node transmits the address data of the server node and file data of the first contents to the first client that has requested the contents service (S725). This is for allowing the selected server node to request again the corresponding contents service.

Also, when the first client requests the corresponding server node to provide contents service (S730), the server node changes synchronization data of the first contents (S735) and provides the corresponding service in response to the service request of the first client (S740).

At this point, it is preferable that the server node changes a value of a Flag_S of the first contents into “Yes” so that the Flag_S represents the first contents are in service, and stores an address of the first client in an IP_S of the first contents.

Also, the server node compares an IP_D with an IP_S of the first contents. When the IP_D and the IP_S are the same, the server node further performs an operation of changing a value of the Flag_D of the contents into “No” so that the Flag_D represents the address data of the server node can be informed of to other client.

Meanwhile, when service providing of the first contents in response to the request of the first client is ended (S745), the server node changes synchronization data of corresponding contents to represent the ending of the service providing (S750) At this point, it is preferable that the server node changes a value of the Flag_S of the first contents into “No”.

Also, when a deletion request for second contents different from the contents currently in service occurs while the service of the contents is provided as in the method exemplified in FIG. 9, the contents providing system according to the present invention performs a deletion operation of the second contents in response to the deletion request of the second contents. At this point, the deletion process is similar to the method exemplified in FIG. 8.

Also, when a service request for the first contents is input from a second client while the service of the contents is provided as in the method exemplified in FIG. 9, that is, while service of the first contents is provided to the first client, the contents providing system according to the present invention checks the Flag_D of the first contents to judge whether address data of the server node that is providing the service can be informed of to other client. Also, when the address data of the server node can be informed of to other client as a result of the judgment, it is preferable that the contents providing system further performs an operation of changing a value of a Flag_D of the contents so that the Flag_D represents the address data of the server node that is to provide the contents has been informed of to the other client, and of transmitting the address data of the server node and file data of the first contents to the second client.

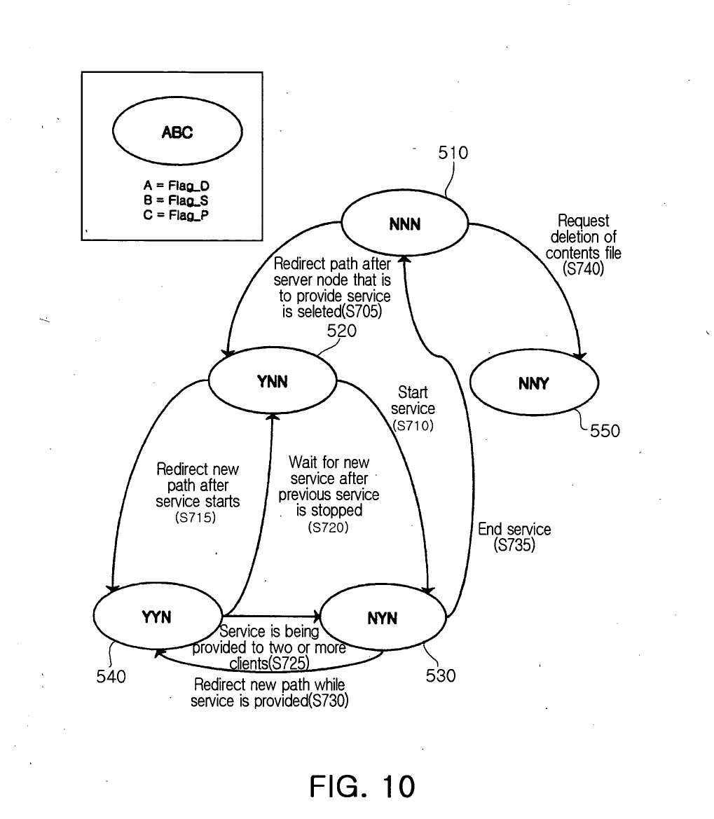

FIG. 10 is a state transition diagram exemplifying a state of synchronization data depending on a contents service providing state at a contents providing system according to an embodiment of the present invention. Particularly, FIG. 10 illustrates all states associated with synchronization which can be given to a contents file after the contents file is newly created and variations of these states in a contents providing system of the present invention. Here, the state is formed as a combination of Flag_D/Flag_S/Flag_P, which are three synchronization flag variables defined in FIG. 4 (Yes is represented by “Y”, and No by “N”). Basically, “NYY”, “YNY”, and “YYY”, which are combinations of flags not defined in FIG. 10 means a contents file is improperly deleted (that is, deletion of a content file that is in service or is scheduled to be provided). Therefore, the fact that the above-mentioned three improper states are not present in a state transition diagram means it is possible to prevent the state of the synchronization data from changing into one of these improper states using a synchronization method proposed by the present invention. That is, the synchronization method prevents a contents file from being improperly deleted.

Referring to FIG. 10, when a contents file is initially generated, the state of the contents file becomes “NNN” 510. When a service request for contents is received from a client with a corresponding content file being in a state of NNN 510, the contents providing system of the present invention informs an address of a server node for providing service of the contents to the client (S705), and changes a state of the corresponding contents into “YNN” 520.

When deletion for the corresponding contents is requested under the state of NNN 210 (S740), the contents providing system prohibits service of the corresponding contents file and changes a state of the corresponding contents into “NNY” 550 in order to delete the contents file.

Meanwhile, when a state of the contents is “YNN” 520 and the server node starts service (S710), the contents providing system changes the state of the contents into “NYN” 530. However, when a new path redirection occurs since the starting of the service in response to a contents service request from other client with the state of the contents being “YNN” 520 (S715), the corresponding contents becomes a state of “YYN” 540.

Also, when previous service is stopped and new service is not started with the state of the contents being “YYN” 540 (S720), the contents providing system of the present invention will change the state of the contents into “YNN” 520. Meanwhile, when service providing is added while the previous service is provided or in response to a request of other client with the state of the contents being “YYN” 540 (for example, when one contents file is simultaneously provided to two or more clients) (S725), the contents providing system of the present invention changes the state of the contents into “NYN” 530.

Also, when a new client, not a client connected to a current node, requests again the same contents file to generate a path redirection while service of the corresponding contents file is performed with the state of the contents being “NYN” 530 (S730), the contents providing system of the present invention changes the state of the contents into “YYN” 540.

Meanwhile, when the service of the corresponding contents is ended with the state of the contents being “NYN” 530 (S735), the contents providing system of the present invention changes the state of the contents into “NNN” 510.

When the corresponding contents file is deleted with the state of the contents being “NNY” 550, the contents providing system of the present invention deletes a record of the corresponding file.

The above-described contents providing system, contents providing method, and contents management method fundamentally prevent service that has been or is scheduled to be provided to a client from being stopped due to improper deletion of a contents file of the contents providing system by allowing the contents providing system including a plurality of nodes to manage synchronization data between the nodes. Therefore, high quality reliable service can be provided to clients.

While the present invention has been shown and described in connection with the preferred embodiments, it will be apparent to those skilled in the art that modifications and variations can be made without departing from the spirit and scope of the invention as defined by the appended claims.

What is claimed is:

1. A contents providing system for preventing improper deletion of contents, the system comprising:
a contents storing unit for storing contents data that are provided;
a synchronization data storing unit for storing synchronization data according to a service state of each contents data stored in the contents storing unit;
a plurality of server nodes for changing synchronization data of contents, and providing the contents service in response to a contents service request input via a network;
a dispatcher node for checking a service state of contents from the synchronization data storing unit to select a server node that is to provide corresponding contents service, and changing synchronization data of corresponding contents to transmit address data of the selected server node and corresponding contents file data to a client that has requested the contents service in response to a contents service request input via a network; and
a storing/deleting management node for managing storing and deleting of contents data stored in the contents storing unit with reference to the synchronization data stored in the synchronization data storing unit.

2. The system of claim 1, wherein each of the plurality of server nodes operates in response to a service request of a client that has received address data of a server node from the dispatcher node.

3. The system of claim 1, wherein the synchronization data storing unit stores synchronization data including at least one of identification data for identifying contents, a path redirection flag Flag_D displaying a path redirection state representing whether address data of a server node that is to provide contents has been informed of to the client, a service providing flag Flag_S representing whether the selected server node is actually providing corresponding contents, a contents deletion Flag_P representing whether the storing/deleting management node is deleting corresponding contents, a first address data IP_D representing address data of the client that has been informed of address data of the server node selected by the dispatcher node, and a second address data IP_S representing address data of a client that is receiving contents service from the server node.

4. The system of claim 3, wherein the dispatcher node checks the contents deletion Flag_P of the service-requested contents, and when the corresponding contents are not being deleted, the dispatcher node changes a state of the path redirection flag Flag_D of the contents so that the Flag_D represents the address data of the server node that is to provide contents has been informed of to the client, stores an address of the client in the first address data IP_D of the contents, and transmits address data of the selected server node and file data of corresponding contents to the client that has requested the content service.

5. The system of claim 4, wherein the server node changes a state of the service providing flag Flag_S of the contents so that the Flag_S represents the service-requested contents is in service, stores an address of the client in the second address data IP_S of the contents, and provides the corresponding contents service.

6. The system of claim 5, wherein, when the first address data IP_D is the same as the second address data IP_S, the server node changes the state of the path redirection flag Flag_D of the contents so that the Flag_D represents that the address data of the server node that is to provide the contents can be informed of to another client.

7. The system of claim 6, wherein, when service of contents currently in service is ended, the server node changes the state of the service providing flag Flag_S so that the Flag_S represents the service of the contents has been ended.

8. The system of claim 3, wherein, when contents to be deleted occurs, the storing/deleting management node checks the Flag_D and the Flag_S of the corresponding contents, and when it is judged that address data of a server node that is to provide the corresponding contents can be informed of to other client, and the contents are not in service as a result of the checking, the storing/deleting management node changes the Flag_P of the corresponding contents so that the Flag_P represents the contents are being deleted, and deletes the contents.

9. The system of claim 8, wherein, after the contents are completely deleted, the storing/deleting management node changes the Flag_P so that the Flag_P represents the contents are not being deleted.

10. The system of claims 1, wherein at least one of the contents storing unit, the synchronization data storing unit, the plurality of server nodes, the dispatcher node, and the storing/deleting management node comprises at least one physical device.

11. A contents providing method for preventing improper deletion of contents, the method comprising:
initialing synchronization data of each contents data that is to be provided;
selecting a server node that is to provide first contents in response to a service request for the first contents input via a network;
changing synchronization data of the first contents;
transmitting address data of the server node and file data of the first contents to a first client that has requested the first contents; and
changing synchronization data of the first contents and providing the first contents in response to the service request of the first client.

12. The method of claim 11, wherein the initialing of synchronization data comprises initializing synchronization data including at least one of identification data for identifying contents, a path redirection flag Flag_D displaying a path redirection state representing whether address data of a server node that is to provide contents has been informed of to the client, a service providing flag Flag_S representing whether the selected server node is actually providing corresponding contents, a contents deletion Flag_P representing whether the storing/deleting management node is deleting corresponding contents, a first address data IP_D representing address data of the client that has been informed of address data of the server node selected by the dispatcher node, and a second address data IP_S representing address data of a client that is receiving contents service from the server node.

13. The method of claim 12, wherein the selecting of the server node comprises:
checking a Flag_P of the first contents; and
when the first contents are not being deleted, selecting the server node.

14. The method of claim 12, wherein the changing of the synchronization data comprises:
changing a value of a Flag_D of the first contents so that the Flag_D represents that address data of the server node that is to provide the first contents has been informed of to a predetermined client; and
storing an address of the first client in an IP_D of the first contents.

15. The method of claim 12, wherein the changing of the synchronization data of the first contents and the providing the first contents comprises:
changing a value of a Flag_S of the first contents so that the Flag_S represents the first contents are in service;
storing an address of the first client in an IP_S of the first contents; and
providing service of the first contents to the first client.

16. The method of claim 15, wherein the changing of the synchronization data of the first contents and the providing the first contents further comprises:
comparing an IP_D of the first contents with an IP_S of the first contents; and
when the IP_D and the IP_S are the same as a result of the comparison, changing the value of the Flag_D of the contents so that the Flag_D represents address data of the server node can be informed of to other client.

17. The method of claim 12, further comprising:
when the providing of the first contents in response to the request of the first client is ended, changing a value of the Flag_S of the first contents so that the Flag_S represents the providing of the first contents has been ended.

18. The method of claim 12, further comprising:
checking a Flag_D of the second contents and judging whether address data of a server node that is to provide the second contents can be informed of to a predetermined client in response to a deletion request for the second contents;
checking a Flag_S of the second contents to judge whether the second contents are in service;
when the address data of the server node that is to provide the second contents can be informed of to the predetermined client and the second contents are not in service as a result of the judgments, changing a Flag_P of the second contents so that the Flag_P represents the second contents are being deleted; and
deleting the second contents.

19. The method of claim 18, further comprising, after the second contents are completed deleted, changing the Flag_P of the contents so that the Flag_P represents the contents are not being deleted.

20. The method of claim 12, further comprising:
when a service request for the first contents is input from a second client while the first contents service is provided to the first client, checking a Flag_D of the first contents and judging whether address data of the server node that is providing the contents service can be informed of to other client;
when the address data of the server node can be informed of to other client, changing a Flag_D of the contents so that the Flag_D represents the address data of the server node that is to provide the contents has been informed of to the other client; and
transmitting the address data of the server node and file data of the first contents to the second client.

21. A contents management method for preventing improper deletion of contents, the management method comprising:
initialing, at a contents providing system, synchronization data of each contents data that is to be provided; and
changing synchronization data of contents on the basis of a content service request and the contents providing results.

22. The contents management method of claim 21, wherein the initialing of synchronization data comprises initializing synchronization data including at least one of identification data for identifying contents, a path redirection flag Flag_D displaying a path redirection state representing whether address data of a server node that is to provide contents has been informed of to the client, a service providing flag Flag_S representing whether the selected server node is actually providing corresponding contents, a contents deletion Flag_P representing whether the storing/deleting management node is deleting corresponding contents, a first address data IP_D representing address data of the client that has been informed of address data of the server node selected by the dispatcher node, and a second address data IP_S representing address data of a client that is receiving contents service from the server node.

23. The contents management method of claim 22, wherein the changing of the synchronization data comprises:
transmitting the address data of the server node that is to provide first contents and file data of the first contents to a first client;
changing a state of a Flag_D of the first contents so that the Flag_D represents the address data of the server node has been informed of to a predetermined client; and
storing an address of the first client in an IP_D of the first contents.

24. The contents management method of claim 23, wherein the changing of the synchronization data further comprises:
when the first contents are in service, changing a Flag_S of the first contents so that the Flag_S represents the first contents is in service;
storing the address of the first client in an IP_S of second contents;
comparing the IP_D with the IP_S; and
when the IP_D and the IP_S are the same as a result of the comparison, changing the state of the Flag_D of the first contents so that the Flag_D represents the address data of the server node can be informed of to other client.

25. The contents management method of claim 24, wherein the changing of the synchronization data further comprises:
when service providing of the first contents is ended, changing a state of the Flag_S of the first contents so that the Flag_S represents the service providing of the first contents has been ended.

26. The contents management method of claim 25, wherein the changing of the synchronization data further comprises:
checking a Flag_D and a Flag_S of the second contents in response to a deletion request for the second contents, and when it is judged that address data of a server node that is to provide the second contents can be informed of to other client, and the second contents are not in service as a result of the checking, changing a Flag_P of the second contents so that the Flag_P represents the second contents are being deleted; and
after the second contents are completely deleted, changing the Flag_P of the second contents so that the Flag_P represents the second contents are not being deleted.
